(19) United States
(12) Patent Application Publication
(10) Pub. No.: US 2014/0122648 A1
(43) Pub. Date: May 1, 2014

(54) METHOD OF TRANSFERRING IMAGE BETWEEN ELECTRONIC PAPERS, MACHINE READABLE STORAGE MEDIUM, ELECTRONIC DEVICE, AND ELECTRONIC PAPER

(71) Applicant: Samsung Electronics Co., Ltd., Gyeonggi-do (KR)

(72) Inventors: Seong-Woon KANG, Gyeonggi-do (KR); Hee-Min KWON, Seoul (KR); Young-Woong KIM, Seoul (KR); Sung-Jin PARK, Seoul (KR); Kyu-Suk LEE, Gyeonggi-do (KR); Jong-In LEE, Gyeonggi-do (KR); Kyung-Hoon CHA, Gyeonggi-do (KR)

(73) Assignee: Samsung Electronics Co., Ltd., Gyeonggi-do (KR)

(21) Appl. No.: 14/069,884

(22) Filed: Nov. 1, 2013

(30) Foreign Application Priority Data
Nov. 1, 2012 (KR) 10-2012-0123087

(51) Int. Cl. H04L 29/08

(52) U.S. Cl. CPC H04L 67/06
USPC 709/217

(57) ABSTRACT

Disclosed are a method of transferring images between electronic papers, a machine readable storage medium, an electronic device, and an electronic paper. The method includes copying image data stored in a first electronic paper while the first electronic paper is connected to an electronic device, and transferring the copied image data to at least one second electronic paper through connectors such that the copied image data is displayed on the at least one second electronic paper while the at least one second electronic paper is connected to the electronic device through the connectors.

### PRIORITY

This application claims priority under 35 U.S.C. §119(a) to Korean Application Serial No. 10-2012-0123087, which was filed in the Korean Intellectual Property Office on Nov. 1, 2012, the entire content of which is incorporated herein by reference.

### BACKGROUND

1. Field of the Invention

The present invention generally relates to an electronic paper, and more particularly, to a method of transferring images between electronic papers.

2. Description of the Related Art

Paper, the oldest and most widely used media for containing information, can be used by anyone due to its simplicity, and has been widely and generally used in various environments due to low eye strain and easy portability. For sharing data contained in the paper, various Office Automation (OA) equipment such as a printer for printing data, a duplicator for copying data, and a facsimile machine for transmitting data has been utilized.

Although frequently used as a general and convenient media, paper inconveniences users in the sharing of data contained therein. Various expensive OA equipment is required to share data, and an expense of maintaining the OA equipment is increasing. Further, when a large amount of data is simultaneously processed, a corresponding cost and time is taken, which is inefficient in some aspects.

A keypad assembly using an electronic paper has been disclosed in the prior art. U.S. Pat. No. 7,053,799 discloses a technology by which an electronic paper is interposed between a transparent keypad having actuator buttons and a plurality of switches, and is illuminated through the transparent keypad by using light emitting elements disposed between a housing and the transparent keypad, so that symbol patterns on the electronic paper are displayed.

Further, complex connections are required to transfer images between electronic papers at present, thereby inconveniencing users in the sharing of the images.

### SUMMARY

The present invention has been made to at least partially resolve, alleviate, or remove at least one of the problems and/or disadvantages described above, and to provide at least the advantages described below.

Accordingly, an aspect of the present invention provides a method through which image data can be readily shared between electronic papers, without the need for any complex connection method.

In accordance with an aspect of the present invention, a method of transferring images between electronic papers is provided. The method includes copying image data stored in a first electronic paper while the first electronic paper is connected to an electronic device, and transferring the copied image data to at least one second electronic paper such that the copied image data is displayed on the at least one second electronic paper while the at least one second electronic paper is connected to the electronic device.

In accordance with another aspect of the present invention, an electronic paper is provided. The electronic paper includes a memory that stores first image data, an image sheet that displays the first image data, a connector that is exposed on a front surface and a rear surface of the electronic paper, and a controller that outputs the first image data stored in the memory to an external device through the connector.

In accordance with another aspect of the present invention, there are provided a non-transitory computer-readable storage medium in which a program for executing the method of transferring the images between the electronic papers is recorded, and an electronic device including the storage medium.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a first Electro-Phoretic Display (EPD) panel according to an embodiment of the present invention;

FIG. 2 is a sectional view illustrating the first EPD panel;

FIG. 3 is a sectional view illustrating a pixel of a first image sheet;

FIG. 4 is a block diagram illustrating a configuration of a first main board;

FIG. 5 illustrates a method of driving the first image sheet;

FIG. 6 illustrates a circuit configuration of an organic electronic backplane;

FIG. 7 illustrates a first touch sensor and a first touch sensor controller;

FIGS. 8 and 9 illustrate a method of detecting a pen input location;

FIG. 10 illustrates an electronic device according to a first embodiment of the present invention and the first EPD panel which are separated from each other;

FIG. 11 illustrates the electronic device and the first EPD panel which are connected with each other;

FIG. 12 is a plan view illustrating a binder;

FIG. 13 is a side view illustrating the binder;

FIG. 14 is a block diagram illustrating a configuration of a second main board of the electronic device;

FIG. 15 illustrates an electronic device according to a second embodiment of the present invention;

FIG. 16 illustrates the electronic device and the first EPD panel which are connected with each other;

FIGS. 17 to 19 illustrate an image copying method of the present invention; and

FIG. 20 is a flowchart illustrating a method of transferring an image between electronic papers according to an embodiment of the present invention.

### DETAILED DESCRIPTION OF EMBODIMENTS OF THE PRESENT INVENTION

Various embodiments will now be described more fully with reference to the accompanying drawings in which some example embodiments are shown. However, the embodiments do not limit the present invention to a specific implementation, but should be construed as including all modifications, equivalents, and replacements included in the spirit and scope of the present invention.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more of the associated listed items.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component there between.

The terms used in this application is for the purpose of describing particular embodiments only and is not intended to be limiting of the invention. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An Electro-Phoretic Display (EPD) panel of the present invention displays content on an image sheet, and updates a screen of the image sheet according to a user input through an input/output module, a touch sensor, and the like, and an external input through a connector. The content includes a menu screen, a still image (a photo), a document (a digital book, a digital newspaper, a web page, etc.), and the like.

In the present description, the EPD panel will be described as an example of an electronic paper. However, the present invention may be applied to an electronic paper in an arbitrary structure or form that displays content. Accordingly, the EPD panel may be mentioned as an electronic paper, and an EPD controller may be mentioned as an electronic paper controller. Further, the electronic paper may also be defined as a display device that displays content by using ambient light from the outside without any internal illumination unit.

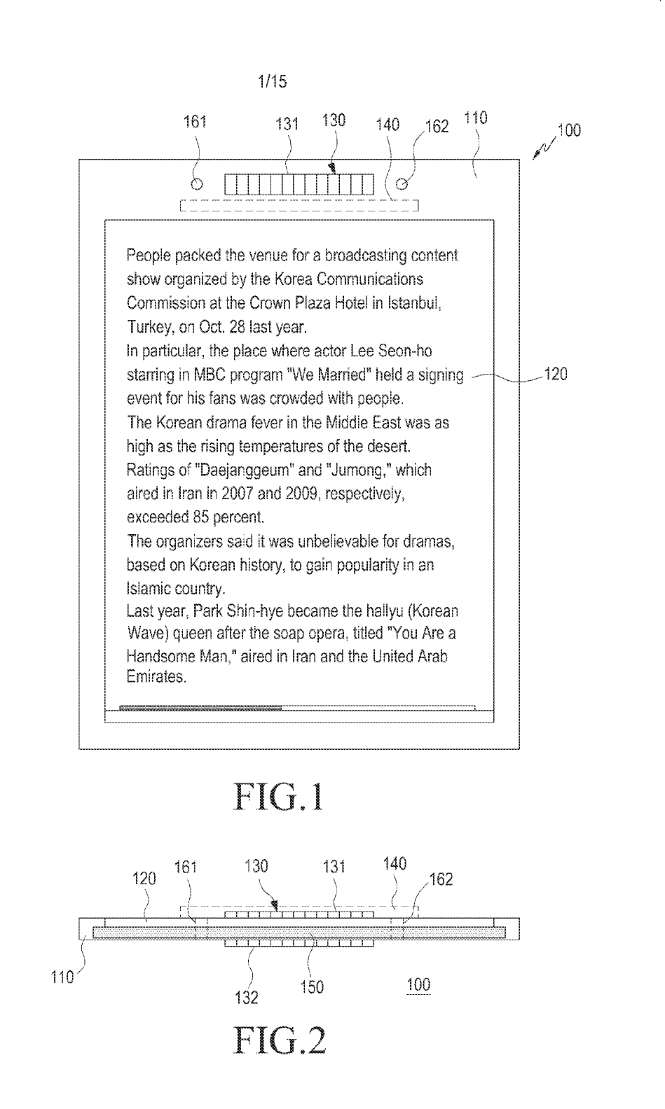

FIG. 1 illustrates a first EPD panel according to an embodiment of the present invention, and FIG. 2 is a sectional view illustrating the first EPD panel.

The first EPD panel 100 includes a first cover sheet 110 that protects other elements in the first EPD panel 100, a first image sheet 120 that displays content, a first touch sensor 150 that senses a user's touch input, a first connector 130 that receives data such as content from an external device, a pair of first fixing members 161 and 162, and a first main board 140 that controls the first image sheet 120 and the first touch sensor 150. The first main board 140 may also be referred to as a main control circuit. The content includes a menu screen, a still image (e.g., a photo), a document (e.g., a digital book, a digital newspaper, a web page, etc.), and the like.

The first cover sheet 110 configures external surfaces of the first EPD panel 100 together with a front surface of the first image sheet 120 to protect the other elements in the first EPD panel 100, and may be formed of a synthetic resin or a plastic such as polyimide, Poly-Ethylene Terephthalate (PET), and the like. The first cover sheet 110 may have a rectangular plate shape in which a recess for accommodating the first image sheet 120 is formed. Unlike the present embodiment, the first cover sheet 110 may also have a shape completely enclosing the first image sheet 120 and the other elements in the first EPD panel 100.

The first cover sheet 110 may be selectively applied to the first EPD panel 100, and instead of the first cover sheet 110, a configuration for completely enclosing the other elements of the first EPD panel 100 may also be employed through mutually combining or bonding bottom and top substrates of the first image sheet 120. Hereinafter, “selective application” implies that the corresponding element may be excluded.

The first connector 130 includes a first connector part 131 exposed from a front surface of the first EPD panel 100, and a second connector part 132 exposed from a rear surface of the first EPD panel 100. The first and second connector parts 131 and 132 are electrically connected with each other, and the first connector 130 outputs first image data, input from an external device, to a first controller 200 (see FIG. 4) in the first EPD panel 100 and outputs second image data, input from the first controller 200, to the external device.

The first fixing members 161 and 162 help an arrangement of the first EPD panel 100 when the first EPD panel 100 is mounted to an external electronic device, and may be implemented as a pair of holes passing through the first EPD panel 100. For example, the first fixing members 161 and 162 may be coupled with second fixing members of the external electronic device as illustrated in FIG. 12.

The first image sheet 120 has a structure in which pixels having the same configuration are arranged in an N×M matrix structure. Images displayed on a screen of the first image sheet 120 (i.e., an upper surface of the first image sheet 120) are configured with a set of points displayed by the pixels.

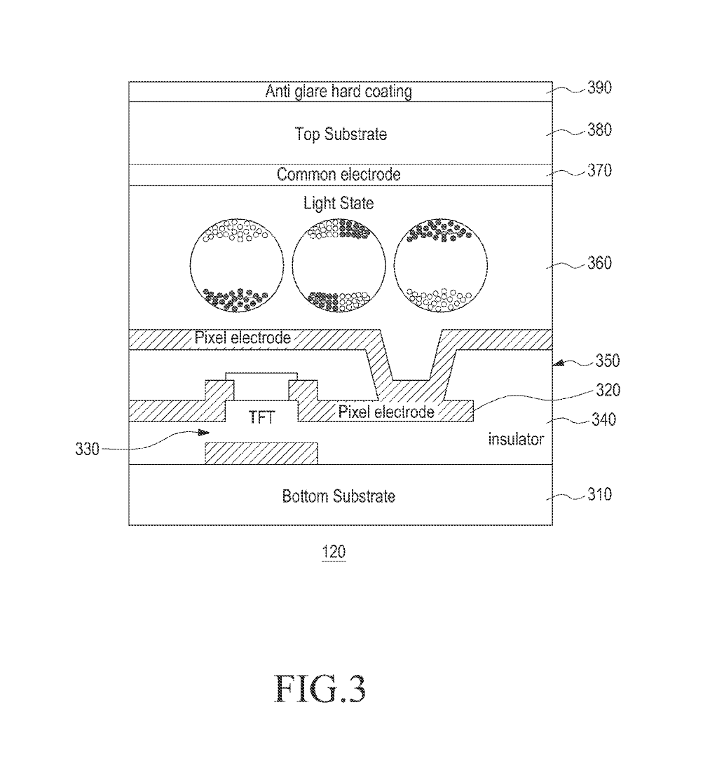

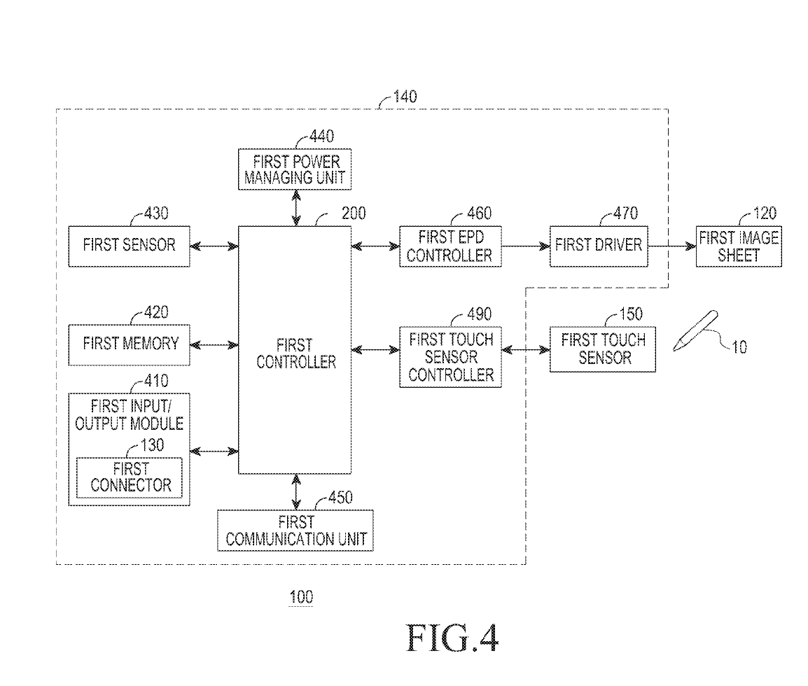

FIG. 3 is a sectional view illustrating a pixel of the first image sheet. Materials and thicknesses of respective elements configuring the first image sheet 120 are set to make the first image sheet 120 flexible and thin.

The first image sheet 120 is illuminated by ambient light from the outside, and displays content through reflection or absorption of the light.

The first image sheet 120 includes a bottom substrate 310, an organic electronic backplane 350 that is an electrode layer, an ink layer 360, a common electrode layer 370, a top substrate 380, and a hard coating layer 390, which are sequentially stacked.

The bottom and top substrates 310 and 380 protect the ink layer 360 and the electrode layers 350 and 370, and a film made of a synthetic resin or a plastic such as polyimide, PET, and the like which can secure heat resistance and high transmissivity, and provide a comfortable writing experience may be used as the substrates 310 and 380. The bottom substrate 310 may have a thickness ranging from 20 μm to 30 μm, preferably from 22.5 μm to 27.5 μm.

The hard coating layer 390 is stacked on an upper surface of the top substrate 380, and may provide a function of preventing glare. For example, the hard coating layer 390 may be formed of a material in which a light scattering material is added to a general hard coating material. The hard coating layer 390 may be selectively applied to the top substrate 380, and the hard coating layer 390 and the top substrate 380 may have a thickness ranging from 24 μm to 36 μm, preferably from 27 μm to 33 μm.

The ink layer 360 represents a color or grayscale image pattern through a movement of particles according to an applied electric field (i.e., an electrophoresis phenomenon), and displays an image through reflection or absorption of external light incident to the pattern. For example, the ink layer 360 has a configuration in which microcapsules filled with transparent fluidic liquid containing white and black particles are arranged between the organic electronic backplane 350 and the common electrode layer 370, and displays a black or white image pattern when an electric field is applied to the microcapsules. For example, the white particles are positively charged and the black particles are negatively charged so that the white and black particles move in opposite directions according to the applied electric field. The image pattern of the ink layer 360 is maintained until a point in time when the electric field is changed. The ink layer 360 may display a color image pattern, and the color display may be implemented by stacking a color filter above the ink layer 360, or by using colored particles instead of black and white particles to configure the ink layer 360.

The common electrode layer 370 is interposed between the ink layer 360 and the top substrate 380, maintained at a predetermined electric potential, and connected with the ground. The common electrode layer 370 and the ink layer 360 may have a thickness ranging from 32 μm to 48 μm, preferably from 36 μm to 44 μm.

The organic electronic backplane 350 is divided into a plurality of pixels, and each of the pixels includes a pixel electrode 320 and a Thin Film Transistor (TFT) 330. A part or all of the pixel electrode 320 and a part or all of the thin film transistor 330 are buried in an insulating layer 340 or are stacked on an upper surface of the insulating layer 340. Conductive parts such as the pixel electrode 320 and the thin film transistor 330 of the organic electronic backplane 350, and the common electrode layer 370 are formed of an organic material containing carbon, and the organic material may be, for example, graphene. The organic electronic backplane 350 may have a thickness ranging from 4 μm to 6 μm, preferably from 4.5 μm to 5.5 μm.

The first image sheet 120 may have, as a whole, a thickness ranging from 0.08 mm to 0.2 mm, preferably from 0.09 mm to 0.11 mm. An electronic paper may be configured with only the first image sheet 120 may configure a single electronic paper, and the electronic paper may also have a thickness ranging from 0.08 mm to 0.2 mm, preferably from 0.09 mm to 0.11 mm.

FIG. 4 is a block diagram illustrating a configuration of the first main board.

The first main board 140 includes a first input/output module 410, a first memory 420, a first sensor 430, a first power managing unit 440, a first communication unit 450, a first EPD controller 460, a first driver 470, a first touch sensor controller 490, and a first controller 200. The first EPD controller 460, the first driver 470, and the first touch sensor controller 490 may be integrated into the first controller 200, and functions thereof may be performed by the first controller 200.

The first EPD panel 100 may perform an image transfer method through interworking with an external electronic device, may receive content (i.e., image data), which a user requires, through a communication network such as the Internet, etc., and may transfer an image representing the content to the first image sheet 120. For example, the first EPD panel 100 may operate according to a control of an electronic device, and the control through the electronic device may be implemented with various methods.

The first communication unit 450 may be a wired or wireless communication unit. The first communication unit 450 transmits, to an external device, data from the first controller 200 in a wired or wireless manner, or receives data through an external communication line or the atmosphere in a wired or wireless manner to transfer the received data to the first controller 200.

The first communication unit 450 may include at least one of a mobile communication module, a wireless Local Area Network (LAN) module, and a short distance communication module according to a performance thereof.

The mobile communication module connects the first EPD panel 100 with an electronic device through mobile communication using at least one antenna (not illustrated) according to a control of the first controller 200. The mobile communication module transmits/receives a wireless signal for a voice call, a video call, a Short Message Service (SMS), or a Multimedia Message Service (MMS) to/from a cellular phone (not illustrated), a smart phone (not illustrated), a tablet Personal Computer (PC), or another communication device (not illustrated), which has a network address such as an Internet Protocol (IP) or a telephone number.

The wireless LAN module may be connected to the Internet according to a control of the first controller 200 in a place where a wireless AP (Access Point) (not illustrated) is installed. The wireless LAN module supports a wireless LAN standard (IEEE802.11x) of the Institute of Electrical and Electronics Engineers (IEEE).

The short distance communication module may make short distance communication with an external short distance communication device (not illustrated) in a wireless manner according to a control of the first controller 200. A short distance communication scheme may include Bluetooth, Infrared Data Association (IrDA) communication, WiFi-Direct communication, Near Field Communication (NFC) and the like.

The first input/output module 410 is a unit that receives a user input, informs a user of information, receives data from an external device, or outputs data to the external device, and may include a first connector 130, a button (not illustrated), a microphone (not illustrated), a speaker (not illustrated), a vibration motor (not illustrated), a keypad (not illustrated), and the like.

The first connector 130 may be used as an interface that connects the first EPD panel 100 with an external electronic device or a power source (not illustrated). The first connector 130 may be connected with a connector of the electronic device directly or by using a wired cable, and through the connection of the connectors, the first controller 200 may transmit first image data stored in the first memory 420 of the first EPD panel 100 to the electronic device, or may receive second image data from the electronic device.

The first controller 200 may store the received second image data in the first memory 420, or may transfer the received second image data to the first image sheet 120. Further, the first EPD panel 100 may receive electrical power from a power source through a wired cable connected to the first connector 130 to charge a battery.

The button of the first input/output module 410 may be formed on the first main board 140, or on a front surface, a side surface, or a rear surface of the first EPD panel 100, and may include a power/lock button, a volume button, a menu button, a home button, a back button, a search button, and the like.

The microphone of the first input/output module 410 may receive a voice or a sound to generate an electrical signal, according to a control of the first controller 200.

The speaker of the first input/output module 410 may output a sound corresponding to various signals (e.g., a wireless signal, a broadcasting signal, a digital audio file, a digital video file, photographing, or the like) to the outside of the first EPD panel 100 according to a control of the first controller 200. The speaker may output a sound corresponding to a function that the first EPD panel 100 performs. Any number of speakers may be installed in the first main board 140 or at suitable locations of the first EPD panel 100.

The vibration motor of the first input/output module 410 may transform an electrical signal into a mechanical vibration according to a control of the first controller 200. For example, the first EPD panel 100 in a vibration mode may operate the vibration motor, when a voice call is received from another device (not illustrated). Any number of vibration motors may be installed in the first main board 140 or the first EPD panel 100. The vibration motor may operates in response to a user's touch motion of touching the first image sheet 120 and continuous movements of a touch (i.e., a drag) on the first image sheet 120.

The keypad of the first input/output module 410 may receive a key input from a user for a control of the first EPD panel 100. The keypad may include a physical keypad formed in the first main board 140 or the first EPD panel 100, or a virtual keypad displayed on the first image sheet 120.

The first sensor 430 includes at least one sensor that detects a status of the first EPD panel 100. For example, the first sensor 430 may include a proximity sensor that detects user access to the first EPD panel 100 or a motion/direction sensor that detects a motion of the first EPD panel 100 (e.g., rotation, acceleration, deceleration, vibration, and the like of the first EPD panel 100). In addition, the motion/direction sensor may include, for example, an acceleration sensor, a gravity sensor, a terrestrial magnetism sensor, a gyro sensor, an impact sensor, a Global Positioning System (GPS) sensor, and a compass sensor. The first sensor 430 may detect a status of the first EPD panel 100, and may generate a signal corresponding to the detection to transmit the generated signal to the first controller 200. For example, a GPS sensor may receive electric waves from a plurality of GPS satellites in Earth's orbit, and may calculate a location of the first EPD panel 100 by using the time of arrival of the electric waves from the GPS satellites to the first EPD panel 100. The compass sensor calculates a posture or a direction of the first EPD panel 100.

The first sensor 430 may also include a camera that photographs a still image or a moving image according to a control of the first controller 200.

The camera may include a lens system, an image sensor, a flash, and the like. The camera may convert an optical signal input (or photographed) through the lens system to an electrical image signal to output the electrical image signal to the first controller 200, and a user may photograph a moving image or a still image through the camera.

The lens system causes light incident from the outside to converge to form an image of a subject. The lens system includes one or more lenses, each of which may be, for example, a convex lens or an aspheric lens. The lens system is symmetric with reference to an optical axis that passes the center of the lens system in which the optical axis is defined as the central axis. The image sensor detects an optical image formed by the external light incident through the lens system as an electrical image signal. The image sensor includes a plurality of pixel units arranged in an M×N matrix structure and each of the pixel units may include a photodiode and a plurality of transistors. The pixel units accumulate electric charges generated by the incident light and the voltage induced by the accumulated electric charges indicates the intensity of illumination of the incident light. In processing an image that forms a still image or a moving image, the image signal output from the image sensor is configured by an aggregation of the voltages (i.e., pixel values) output from the pixel units and the image signal indicates one frame (i.e., still image). Also, the frame is configured by M×N pixels. As the image sensor, for example, a CCD (charge-coupled device) image sensor or a CMOS (complementary metal-oxide semiconductor) image sensor may be used.

The image sensor may operate all pixels of the image sensor, or only some pixels in an area of interest among all the pixels according to a control signal received from the first controller 200, and image data output from the pixels is output to the first controller 200.

The first controller 200 processes images input from the camera or images stored in the first memory 420 on a frame-by-frame basis. The first controller 200 may output, to the first image sheet 120, image frames converted to correspond to a screen property (e.g., a size, a definition, a resolution, and the like) of the first image sheet 120, or may store the converted image frames in the first memory 420.

The first image sheet 120 may provide, to users, a Graphic User Interface (GUI) corresponding to various services (e.g., a call, data transmission, broadcasting, and photography). A first touch sensor 150 may transmit a signal corresponding to at least one touch to the first controller 200. The first touch sensor 150 may receive an input of at least one touch through a user's body (e.g., fingers) or a touchable input unit (e.g., a stylus pen). Further, the first touch sensor 150 may receive an input of a continuous movement of a touch (i.e., a drag). The first touch sensor 150 may transmit a signal corresponding to the continuous movement of the input touch to the first controller 200.

In an embodiment of the present invention, the touch is not limited to contact between the first image sheet 120 and the user's body or the touchable input unit, and may include non-contact (e.g., a case in which the first image sheet 120 and the user's body or the touchable input unit are spaced apart from each other). Although the first touch sensor 150 implemented through an Electro-Magnetic Resonance (EMR) scheme is described in the present embodiment, the first touch sensor 150 may also be implemented through a resistive scheme, a capacitive scheme, an infrared scheme, an acoustic wave scheme, and the like.

The first controller 200 controls an overall operation of the first EPD panel 100, and performs an image transfer method by controlling the other elements in the first EPD panel 100. The first controller 200 may also be referred to as a main controller to be distinguished from other controllers. The first controller 200 may include a single core, a dual core, a triple core, or a quad core. The first controller 200 may receive, through the first communication unit 450, a broadcasting signal (e.g., a Television (TV) broadcasting signal, a radio broadcasting signal, or a data broadcasting signal) and broadcasting additional information (e.g., an Electronic Program Guide (EPG) or an Electronic Service Guide (ESG)), which are transmitted from a broadcasting station. The first controller 200 may play a digital audio file (e.g., a file with an extension such as mp3, wma, ogg, or way) stored in the first memory 420 or received through the first communication unit 450. The first controller 200 may play a digital video file (e.g., a file with extension such as mpeg, mpg, mp4, avi, mov, or mkv) stored in the first memory 420 or received through the first communication unit 450. The first controller 200 may display, on the first image sheet 120, image data stored in the first memory 420 or received through the first communication unit 450 according to a user command, a menu selection, or event information which is input through the first sensor 430, the first input/output module 410, or the first touch sensor 150. The image may be a still image or a moving image.

The first memory 420 stores signals or data according to a control of the first controller 200. The first memory 420 may also store control programs or applications for the first EPD panel 100 or the first controller 200.

The term “memory” may include a Read Only Memory (ROM) or a Random Access Memory (RAM) in the first controller 200, a memory card (e.g., a Secure Digital (SD) card or a memory stick), a non-volatile memory, a volatile memory, a Hard Disk Drive (HDD), or a Solid State Drive (SDD), which is mounted to the first EPD panel 100.

The first power managing unit 440 supplies electrical power to the first EPD panel 100 according to a control of the first controller 200. The first power managing unit 440 may be connected to batteries or may supply, to the first EPD panel 100, an electrical power input from an external power source through a wired cable connected with the first connector 130.

The first EPD controller 460 outputs, to the first driver 470, a control signal for driving the first image sheet 120, according to a control of the first controller 200 and an EPD driving algorithm set in advance. The first controller 200 may control the first EPD controller 460 to adjust or update content displayed on the first image sheet 120 according to a user input or an external input.

When the EPD driving algorithm set in advance has been designed in view of external environments, the first EPD controller 460 receives sensing data related to the external environments, which has been measured by the first sensor 430. The first sensor 430 may include a temperature sensor, an illumination sensor, a humidity sensor, and the like.

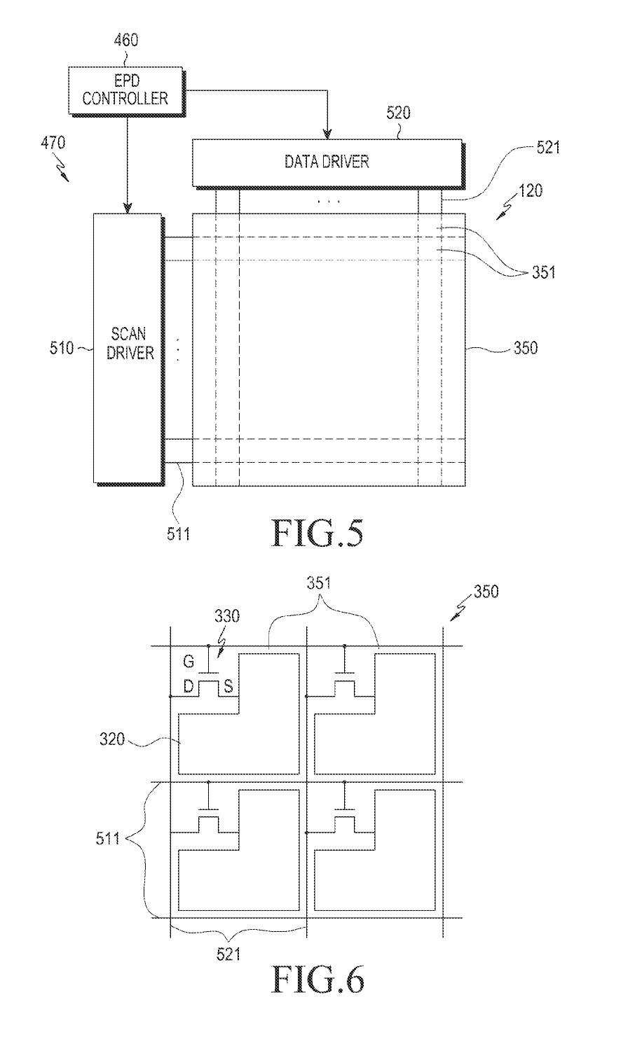

FIG. 5 illustrates a method of driving the first image sheet, and FIG. 6 illustrates a circuit configuration of the organic electronic backplane.

The first driver 470 generates address signals (i.e., a row signal) and data signals (i.e., a column signal) according to a control signal input from the first EPD controller 460 for displaying the image data, and outputs the address signals and the data signals to the organic electronic backplane 350. The first driver 470 includes a scan driver 510 and a data driver 520. The scan driver 510 sequentially provides the address signals to scan lines 511 according to a control of the first EPD controller 460, and the data driver 520 provides the data signals to data lines 521 according to a control of the first EPD controller 460.

The organic electronic backplane 350 includes a plurality of pixels 351, and each of the pixels 351 includes a pixel electrode 320 and a thin film transistor 330. The pixel electrode 320 is connected to the corresponding scan line 511 and the corresponding data line 521 through the corresponding thin film transistor 330. The thin film transistor 330 includes a Gate (G), a Drain (D), and a Source (S). The Gate (G) is connected with the corresponding scan line 511, the Drain (D) is connected with the corresponding data line 521, and the Source (S) is connected with the corresponding pixel electrode 320. The thin film transistor 330 functions as an On/Off switch, and is switched on only when the signals are provided to both the scan line 511 and the data line 521, which have been connected thereto, and a voltage is applied to the pixel electrode 320 while the thin film transistor 330 is switched on.

The ink layer 360 represents an image pattern through movement of particles according to an electric field applied between the common electrode layer 370 and the organic electronic backplane 350. The ink layer 360 has an image pattern according to the above-described image transfer process, and the image pattern is maintained until the next image transfer process.

The first touch sensor controller 490 outputs, to the first touch sensor 150, a control signal for driving the first touch sensor 150 according to a control of the first controller 200 and a touch sensor driving algorithm set in advance, and outputs, to the first controller 200, user information input to the first touch sensor 150 through a user input unit such as a pen 10, and the like. The first controller 200 may control the first EPD controller 460 to adjust or update content displayed on the first EPD panel 100 according to the user input information. In the present embodiment, the first touch sensor 150 is an EMR type touch sensor.

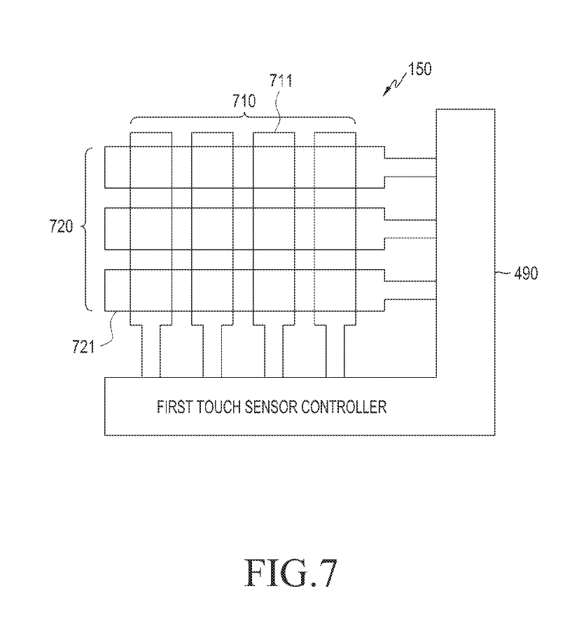

FIG. 7 illustrates the first touch sensor and the first touch sensor controller.

The first touch sensor 150, which is an EMR type touch sensor, includes first and second loop units 710 and 720, operates according to a control of the first touch sensor controller 490, and outputs detected signals to the first touch sensor controller 490. The first loop unit 710 includes a plurality of first loops 711 and the second loop unit 720 includes a plurality of second loops 721.

The first loop unit 710 and the second loop unit 720 may be disposed to be orthogonal to each other.

The first loop unit 710 is made longer in a Y-axis direction than in an X-axis direction, and thus is used to detect an X-coordinate of a pen input location (a user input location or a touch location).

The second loop unit 720 extends relatively long in an X axis in comparison with a Y axis, and accordingly, is used to detect a Y axis coordinate of a pen input position.

The first and second loops 711 and 721 may output a first signal of a first frequency input from the first touch sensor controller 490, by transforming the first signal from an electrical signal form to an electromagnetic wave form. Further, the first and second loops 711 and 721 detect a second signal of a second frequency output from the external pen 10, by transforming the second signal from an electromagnetic wave form to an electrical signal form, and output the detected second signal to the first touch sensor controller 490.

The pen 10 in proximity to the first touch sensor 150 receives the first signal in an electromagnetic wave form, which has been output from the first touch sensor 150, and generates the second signal in an electromagnetic wave form according to operation of a resonance circuit to output the generated second signal to the outside. Meanwhile, the pen 10 is given merely as an example of a user input unit, and any unit that may output the second signal of the second frequency in response to an input of the first signal of the first frequency may be used instead of the pen 10, without limitation. The pen 10 includes a resonance circuit consisting of a coil and a condenser, in which the EMR type first touch sensor 150 may detect a location of the coil and the condenser.

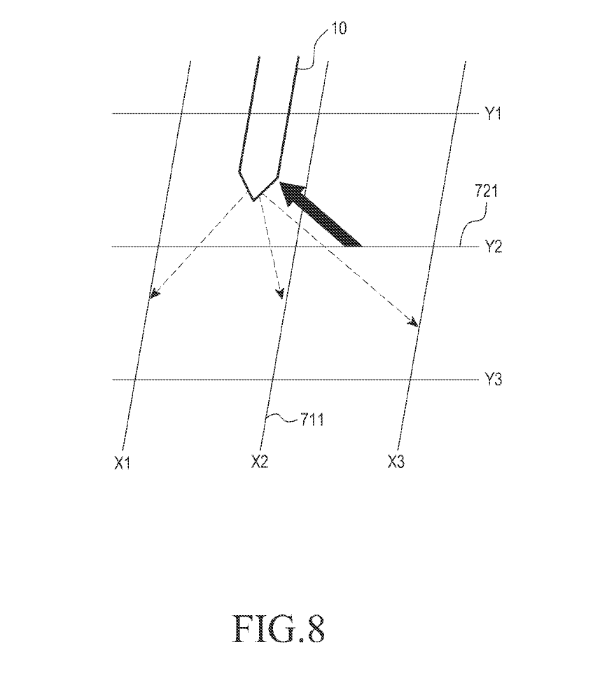

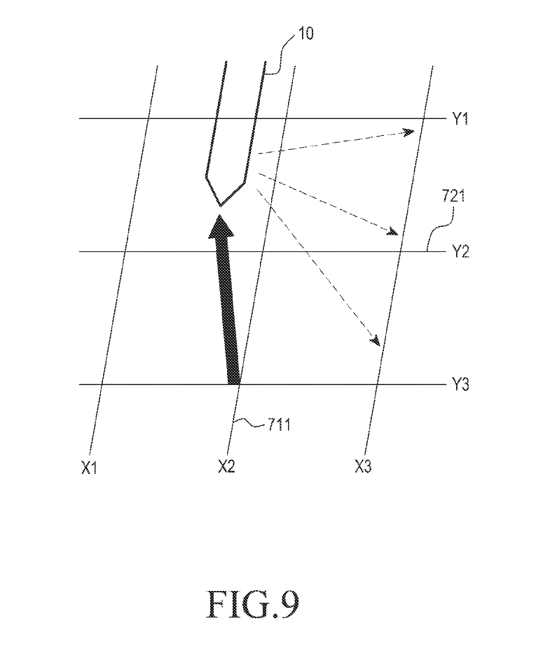

FIGS. 8 and 9 illustrate a method of detecting a pen input location. In FIGS. 8 and 9, each of the first and second loops 711 and 721 is briefly indicated by one line.

Referring to FIG. 8, the second loop 721 (hereinafter, referred to as a Y2 loop) outputs a first signal to the outside, and the pen 10 receives the first signal, generates a second signal, and outputs the generated second signal to the outside. The first loops 711 (hereinafter, referred to as X1, X2, and X3 loops) sequentially detect the second signals. The first touch sensor controller 490 deduces an X-coordinate of the pen input location from the second signal output from the X2 loop among the seconds signals, wherein the second signal output from the X2 loop has a peak voltage value of a first threshold value or greater.

Referring to FIG. 9, the first loop 711 (hereinafter, referred to as an X2 loop) outputs a first signal to the outside, and the pen 10 receives the first signal, generates a second signal, and outputs the generated second signal to the outside. The second loops 721 (hereinafter, referred to as Y1, Y2, and Y3 loops) sequentially detect the second signals. The first touch sensor controller 490 deduces a Y-coordinate of the pen input location from the second signal output from the Y2 loop among the second signals, wherein the second signal output from the Y2 loop has a peak voltage value of the first threshold value or greater.

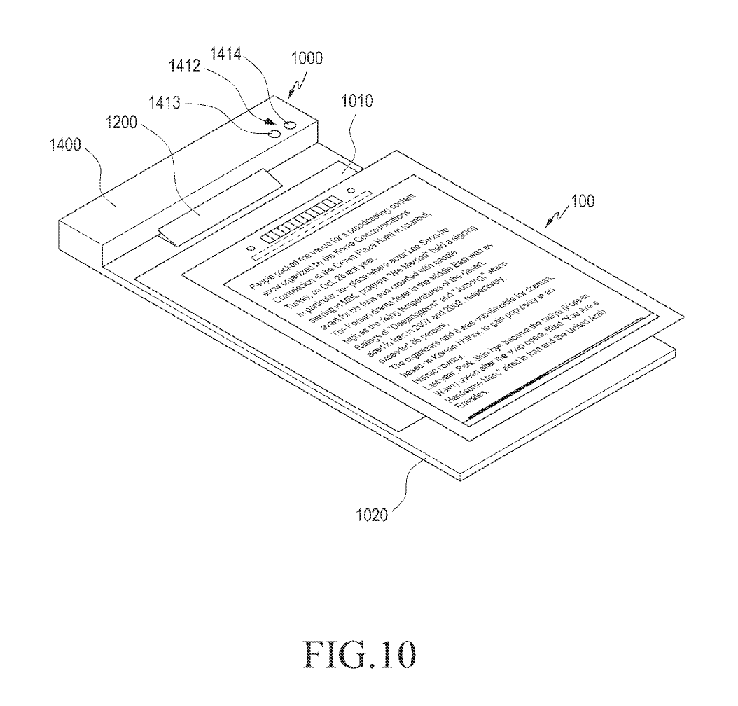

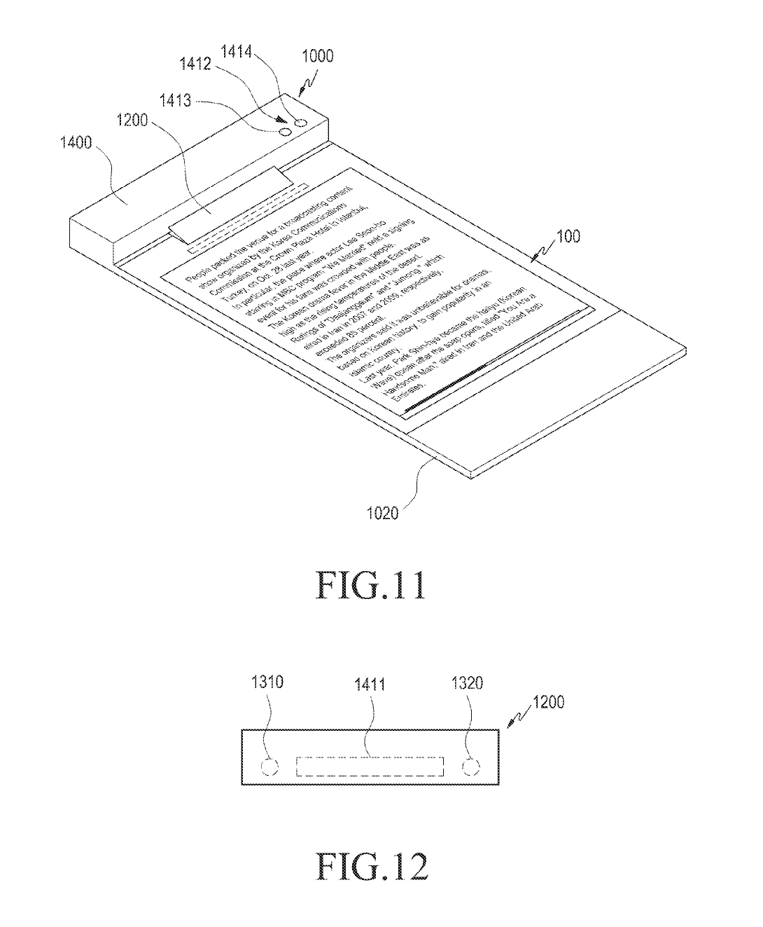

FIG. 10 illustrates an electronic device according to a first embodiment of the present invention and the first EPD panel which are separated from each other, and FIG. 11 illustrates the electronic device and the first EPD panel which are connected with each other.

The electronic device 1000 includes a substrate 1020, a second main board 1400 that is mounted on the substrate 1020, a binder 1200 that fixes the first EPD panel 100, a second touch sensor 1010 that detects a user's touch input, and at least one button 1412 that detects a user's command to copy content. The at least one button 1412 may be a soft button or a mechanical button. The at least one button 1412 includes a first button 1413 that detects a command to copy content, and a second button 1414 that detects a command to paste the content.

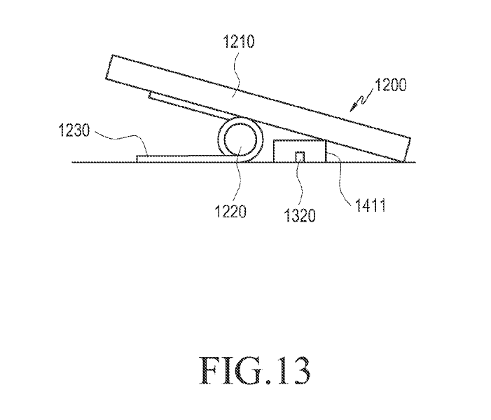

FIG. 12 illustrates the binder, and FIG. 13 is a side view illustrating the binder.

A second connector 1411 and a pair of second fixing members 1310 and 1320 (protrusions in the present embodiment) are formed in an area hidden by the binder 1200 on a top surface of the substrate 1020. The second connector 1411 communicates with the first EPD panel 100, and the pair of second fixing members 1310 and 1320 are disposed at opposite sides of the second connector 1411 and are coupled with the first fixing members 161 and 162 of the first EPD panel 100, respectively. The second fixing members 1310 and 1320 are inserted into the first fixing members 161 and 162 of the first EPD panel 100 in a one-to-one manner. The second connector 1411 is connected with the first connector 130 of the first EPD panel 100.

The binder 1200 includes a push plate 1210 that a user pushes with his hand, a resilient member 1230 such as a spring, and a support member 1220 to which the resilient member 1230 is fixed. When a user pushes one end portion of the push plate 1210, an opposite end portion of the push plate 1210 ascends, and when the user releases the applied force after the first EPD panel 100 is inserted between the opposite end portion of the push plate 1210 and the substrate 1020, the opposite end portion of the push plate 1210 presses and fixes the first EPD panel 100 while descending to an original position by a restoring force of the resilient member 1230.

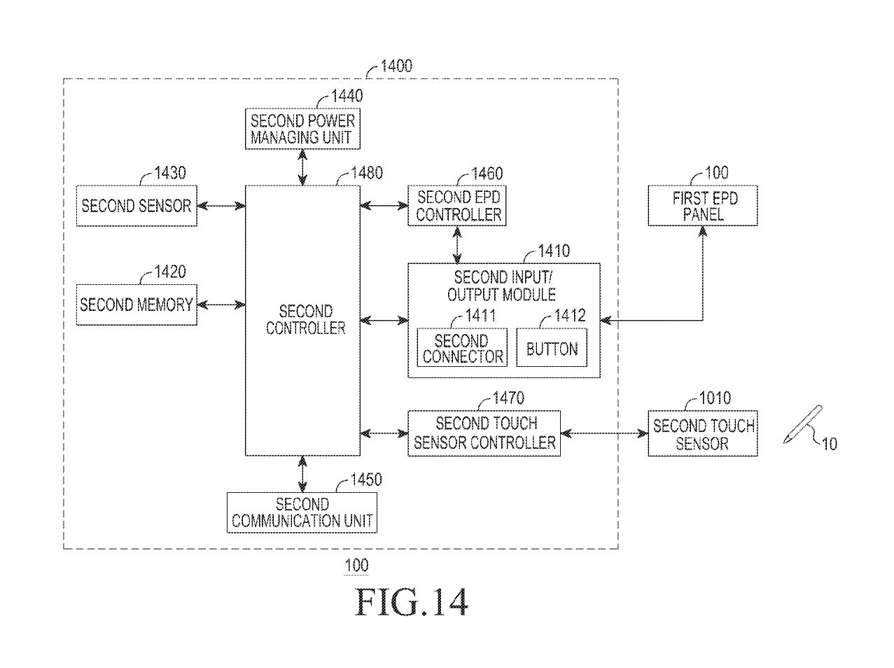

FIG. 14 is a block diagram illustrating a configuration of the second main board of the electronic device.

The second main board 1400 includes a second input/output module 1410, a second memory 1420, a second sensor 1430, a second power managing unit 1440, a second communication unit 1450, a second EPD controller 1460, a second touch sensor controller 1470, and a second controller 1480. The second EPD controller 1460 and the second touch sensor controller 1470 may be integrated into the second controller 1480, and functions thereof may be performed by the second controller 1480.

The second main board 1400 has nearly the same configuration as those of the first main board 140 of the first EPD panel 100. The second main board 1400 performs functions, which the first main board 140 performs, and the first EPD panel 100 transfers to the first image sheet 120, image data input from the electronic device 1000. Since the second main board 1400 has nearly the same configuration as the first main board 140 of the first EPD panel 100, repetitive descriptions will be omitted, and hereinafter, the second main board 1400 will be briefly described.

The second connector 1411 and the first connector 130 are coupled to each other in a contact manner, and the electronic device 1000 and the first EPD panel 100 communicate with each other through the second connector 1411 and the first connector 130.

The electronic device 1000 may perform an image transfer method through interworking with the first EPD panel 100, in which the electronic device 1000 may receive content, which a user requires or desires, through a communication network such as the Internet, etc., and may transfer an image representing the content to the first EPD panel 100.

The electronic device 1000 may be implemented as a portable communication terminal such as a cellular phone, a smart phone, a tablet PC, or the like, which has an image transfer function.

The second communication unit 1450 may be a wired or wireless communication unit. The second communication unit 1450 transmits, to an external device, data from the second controller 1480 in a wired or wireless manner, or receives data from an external communication line or the atmosphere in a wired or wireless manner to transfer the received data to the second controller 1480.

The second input/output module 1410 receives a user input, informs a user of information, receives data from an external device, or outputs data to the external device, and may include the second connector 1411, the button 1412, a microphone, a speaker, a vibration motor, a keypad, a touch screen, and the like.

The touch screen may provide, to a user, a Graphic User Interface (GUI) corresponding to various services (e.g., a call, data transmission, broadcasting, and photography). The touch screen may transmit an analogue signal corresponding to at least one touch to the second controller 1480. The touch screen may receive at least one touch through a user's body (for example, fingers) or a touchable input unit (for example, a stylus pen).

The second connector 1411 is connected with the first connector 130 of the first EPD panel 100 in a contact manner, and the first connector 130 and the second connector 1411 are electrically connected with each other. When a user pushes the first button 1413 in a state in which the connectors have been connected, the second controller 1480 receives the first image data stored in the first memory 420 of the first EPD panel 100 and stores the received first image data in the second memory 1420. When the user pushes the second button 1414 in a state in which the connectors have been connected, the second controller 1480 transfers the second image data stored in advance in the second memory 1420 to the first image sheet 120 of the first EPD panel 100 through the first EPD controller 460 and the first driver 470 of the first EPD panel 100. In the present embodiment, although two buttons are given as examples, only one button may be used, in which case a copy command may be performed when the button is shortly pushed, and a paste command may be performed when the button is pushed for a longer time. Alternatively, when a user pushes the button 1412, a menu including a copy command and a paste command may also be displayed on the first image sheet 120 or the touch screen. Further, when a user selects the paste command of the displayed menu, a list of image data stored in advance may be displayed on the first image sheet 120 or the touch screen, and the user may select image data to transfer.

The second sensor 1430 includes at least one sensor that detects a status of the electronic device 1000. The second sensor 1430 may detect the status of the electronic device 1000 and may generate a corresponding signal to transmit the generated signal to the second controller 1480.

The second controller 1480 controls an overall operation of the electronic device 1000, and controls other elements in the electronic device 1000 to perform an image transfer method. The second controller 1480 may transfer, to the first EPD panel 100, content in an image form stored in the second memory 1420 or received through the second communication unit 1450, according to a user command or a user menu selection input through the first EPD panel 100, the second touch sensor 1010, or the second input/output module 1410.

The second memory 1420 may store signals or data according to a control of the second controller 1480. The second memory 1420 may store control programs and applications for the electronic device 1000 or the second controller 1480.

The second power managing unit 1440 may supply electrical power to the electronic device 1000 according to a control of the second controller 1480.

The second EPD controller 1460 outputs a control signal for driving the first image sheet 120 to the first EPD panel 100 through the second connector 1411 according to a control of the second controller 1480 and an EPD driving algorithm set in advance. The second controller 1480 may control the second EPD controller 1460 to adjust or update content displayed on the first EPD panel 100 according to user input information. The first EPD controller 460 of the first EPD panel 100 transfers, to the first driver 470, the control signal received from the second EPD controller 1460 through the second connector 1411 and the first connector 130. The second EPD controller 1460 is provided in case the first EPD panel 100 does not include the first EPD controller 460. When the first EPD panel 100 includes the first EPD controller 460, the second EPD controller 1460 may be excluded, in which case the second controller may also control the first EPD controller 460 of the first EPD panel 100 without using the second EPD controller 1460.

The second touch sensor controller 1470 outputs a control signal to the second touch sensor 1010 for driving the second touch sensor 1010 according to a control of the second controller 1480 and a touch sensor driving algorithm set in advance, and outputs, to the second controller 1480, the user input information input to the second touch sensor 1010 by using a user input unit such as a pen 10, and the like. The second controller 1480 may control the second EPD controller 1460 to adjust or update content displayed on the first EPD panel 100 according to the user input information. The second touch sensor controller 1470 and the second touch sensor 1010 are provided in case the first EPD panel 100 does not include the first touch sensor controller 490 and the first touch sensor 150. When the first EPD panel 100 includes the first touch sensor controller 490 and the first touch sensor 150, the second touch controller 1470 and the second touch sensor 1010 may be excluded, in which case the second controller 1480 may control the first touch sensor controller 490 of the first EPD panel 100 without using the second touch sensor controller 1470, and may receive the user input information, input to the first touch sensor 150, from the first touch sensor controller 490 through the second connector 1411 and the first connector 130.

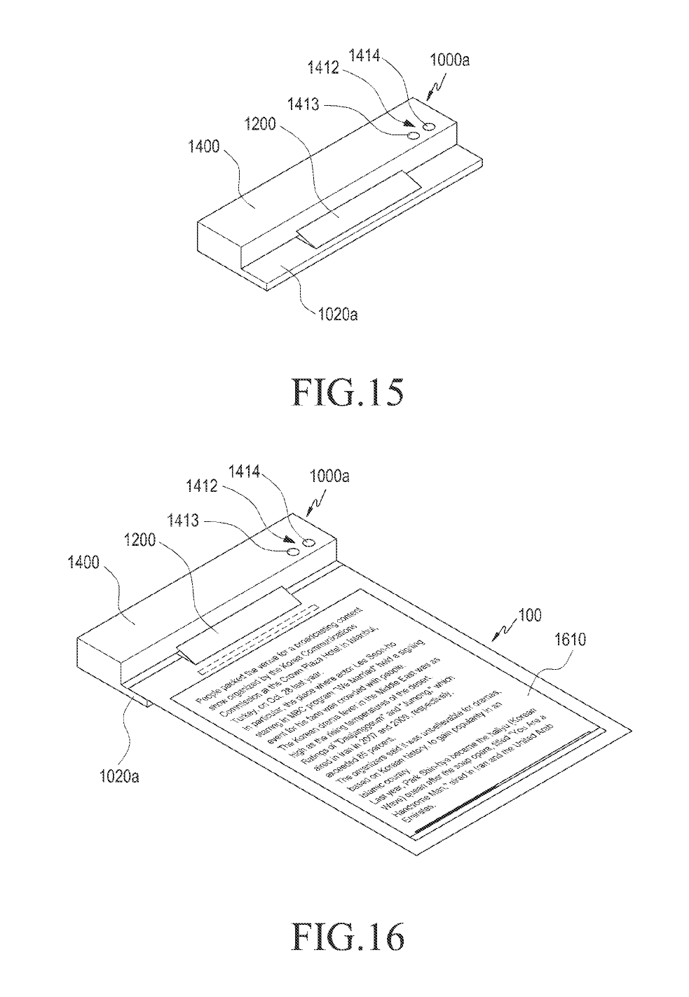

FIG. 15 illustrates an electronic device according to a second embodiment of the present disclosure, and FIG. 16 illustrates the electronic device and the first EPD panel which are connected with each other.

The electronic device 1000a includes a substrate 1020a, a second main board 1400 that is mounted on the substrate 1020a, a binder 1200 that fixes the first EPD panel 100, and at least one button 1412 that detects a user's command to copy content. The at least one button 1412 includes a first button 1413 that detects a command to copy image data, and a second button 1414 that detects a command to paste the image data.

The electronic device 1000a has a similar configuration to the electronic device 1000 according to the first embodiment of the present disclosure, and the only difference between them is that the electronic device 1000a does not include a touch sensor. Thus, repetitive descriptions will be omitted.

Hereinafter, an example in which an image transfer method is performed by using the electronic device 1000a according to the second embodiment of the present invention will be described.

In an initial stage, the first EPD panel 100 displays an original image data 1610 on the first image sheet 120, and the original image data 1610 is stored in the first memory 420 of the first EPD panel 100.

A user mounts the first EPD panel 100 to a binder 1200 of the electronic device 1000a. The second connector 1411 is connected with the first connector 130 of the first EPD panel 100 in a contact manner, and the first connector 130 and the second connector 1411 are electrically connected with each other. When the user pushes the first button 1413 in a state in which the connectors have been connected, the second controller 1480 receives the original image data stored in the first memory 420 of the first EPD panel 100, and stores the received original image data in the second memory 1420.

According to the present invention, the electronic device 1000a may simultaneously transfer the copied image data stored in the second memory 1420 to a plurality of EPD panels, and in the present embodiment, the copied image data is to be simultaneously transferred to the first EPD panel 100 and a second EPD panel 100a.

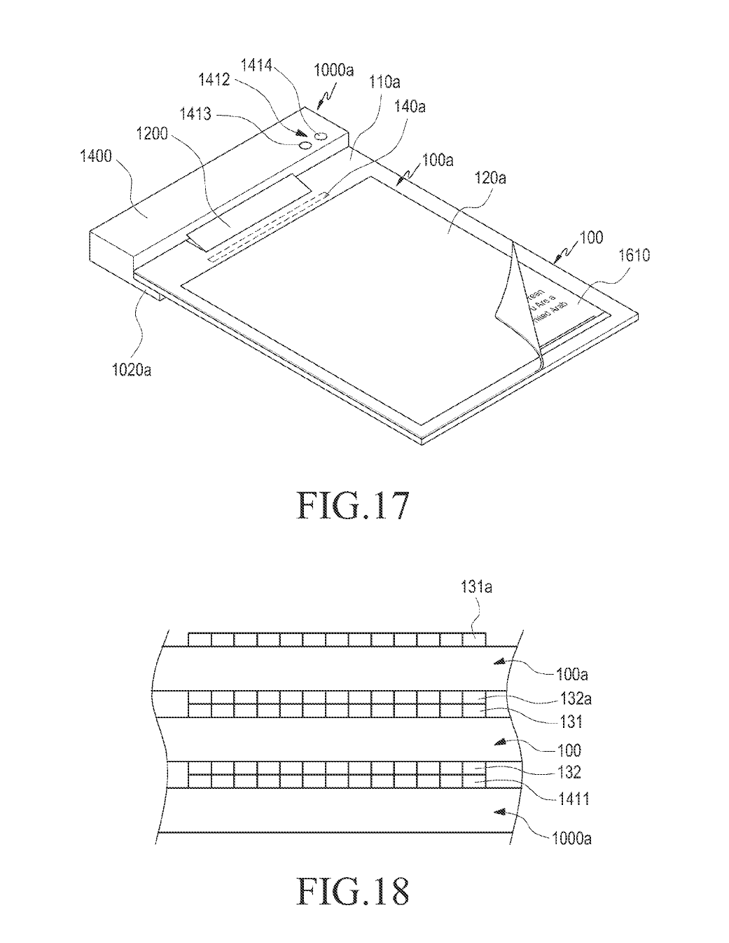

FIGS. 17 to 19 illustrate an image transfer method of the present disclosure.

FIG. 17 illustrates an electronic device to which two EPD panels are connected.

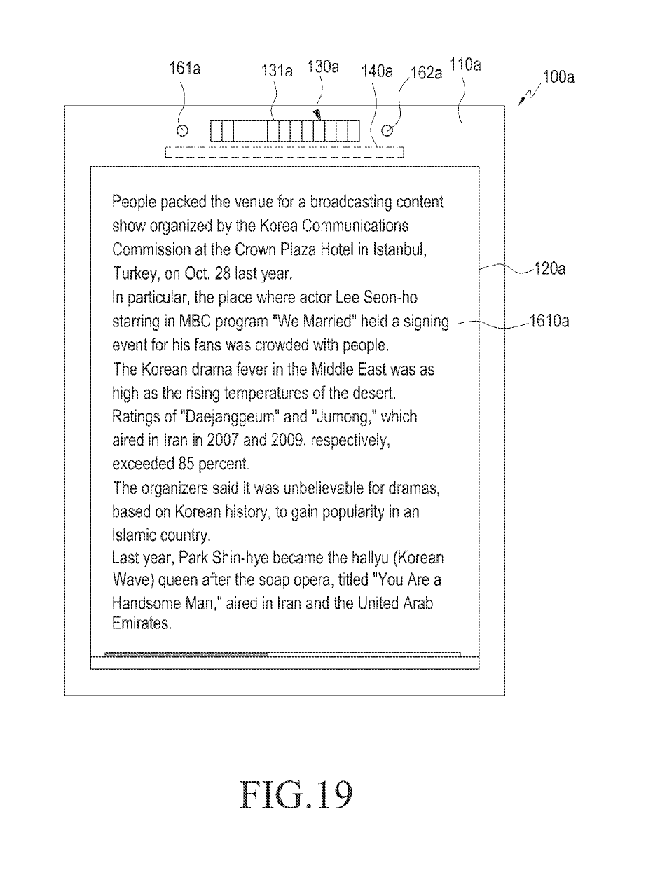

The first EPD panel 100 and the second EPD panel 100a are mounted to the binder 1200 while overlapping each other. As illustrated in FIG. 19, the second EPD panel 100a has the same configurations as those of the first EPD panel 100, and the second EPD panel 100a includes a second cover sheet 110a, a second image sheet 120a, a third touch sensor (not illustrated), a third connector 130a, a pair of third fixing members 161a and 162a, and a third main board 140a

The third connector 130a includes a first connector part 131a that is exposed from a front surface of the second EPD panel 100a, and a second connector part 132a (FIG. 18) that is exposed from a rear surface of the second EPD panel 100a. The first and second connector parts 131a and 132a are electrically connected with each other. The third connector 130a outputs the copied image data, received from the outside, to a third controller (not illustrated) in the third main board 140a, and the third controller stores the copied image data in a third memory (not illustrated) within the third main board 140a, and transfers the copied image data to the second image sheet 120a at the same time.

As illustrated in FIG. 17, in an initial stage, the second EPD panel 100a does not display any image data on the second image sheet 120a.

FIG. 18 illustrates a connection between the connectors of the electronic device, the first EPD panel, and the second EPD panel.

The second connector part 132 of the first connector 130 of the first EPD panel 100 is connected to the second connector 1411 of the electronic device 1000a in a direct contact manner, and the second connector part 132a of the third connector 130a of the second EPD panel 100a is connected to the first connector part 131 of the first connector 130 of the first EPD panel 100 in a direct contact manner. In other words, the second connector 1411 of the electronic device 1000a, the first connector 130 of the first EPD panel 100, and the third connector 130a of the second EPD panel 100a are electrically connected with each other, and the copied image data output from the second connector 1411 of the electronic device 1000a is simultaneously input to the first connector 130 of the first EPD panel 100 and the third connector 130a of the second EPD panel 100a.

When a user pushes the second button 1414 in a state in which the connectors have been connected, the second controller 1480 outputs the copied image data, stored in the second memory 1420, through the second connector 1411, the first EPD panel 100 stores the copied image data received from the electronic device 1000a in the first memory 420 and transfers the copied image data to the first image sheet 120 at the same time, and the second EPD panel 100a stores the copied image data received from the electronic device 1000a in the third memory (not illustrated) and transfers the copied image data to the second image sheet 120a at the same time. Unlike the present embodiment, the copied image data may be stored only in the memory of the second EPD panel 100a, or may also be displayed only on the second image sheet 120a of the second EPD panel 100a.

FIG. 19 illustrates the second EPD panel 100a that displays the image data copied to the second image sheet 120a.

Although the image data stored in the first EPD panel 100 has been transferred to the second EPD panel 100a in the above-described embodiment, a user may input content desired by the user to the first image sheet 120 of the first EPD panel 100 by using a user input unit such as a pen, and the handwritten data may also be transferred to the second EPD panel 100a through the above-described image transfer method.

Further, although the image data of the first EPD panel 100 is copied and then the second EPD panel 100a is mounted to the electronic device 1000a in the above-described embodiment, the first and second EPD panels 100 and 100a are mounted to the electronic device 1000a while overlapping each other, the electronic device 1000a displays the image data of the first and second EPD panels 100 and 100a to a user, and then a copy operation and a transfer operation (i.e., a paste operation) may also be performed._For example, the second controller 1480 may receive a third image data stored in the first EPD panel 100 and a fourth image data stored in the second EPD panel 100a, the second controller 1480 may display the third image data and the fourth image data on the second EPD panel 100a, and then the second controller 1480 may output one of the third and fourth image data selected by the user through the second connector 1411.

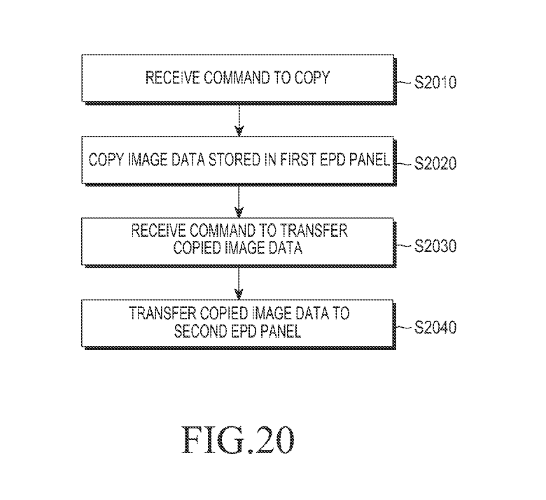

FIG. 20 is a flowchart illustrating a method of transferring an image between electronic papers according to an embodiment of the present invention.

In step S2010, a copy command is received. As a user pushes the first button 1413 of the electronic device 1000a while the first EPD panel 100 is connected to the electronic device 1000a through contact between the first and second connectors 130 and 1411, the second controller 1480 receives the command to copy an original image data stored in the first memory 420 of the first EPD panel 100.

In step S2020, the image data stored in the first EPD panel 100 is copied. The second controller 1480 copies the original image data stored in the first EPD panel 100, by receiving the original image data, stored in the first memory 420 of the first EPD panel 100, through the second connector 1411, and storing the received original image data in the second memory 1420.

In step S2030, a command to transfer the copied image data is received. As the user pushes the second button 1414 of the electronic device 1000a while the first and second EPD panels 100 and 100a are connected to the electronic device 1000a through sequential contact between the second, first, and third connectors 1411, 130, and 130a, the second controller 1480 receives a command to transfer the copied image data stored in the second memory 1420 of the electronic device 1000a. In the present embodiment, the command to transfer the copied image data corresponds to a command by which the copied image data should be transferred to the second EPD panel 100a, by outputting the copied image data through the second connector 1411.

In step S2040, the copied image data is transferred or pasted to the second EPD panel 100a. The second controller 1480 outputs, through the second connector 1411, the copied image data stored in the second memory 1420 of the electronic device 1000a, and the copied image data which has been output is transferred to the first EPD panel 100 through the first connector 130, and is transferred to the second EPD panel 100a through the first and third connectors 130 and 130a. The first EPD panel 100 stores, in the first memory 420, the copied image data received from the electronic device 1000a, and transfers the copied image data to the first image sheet 120 at the same time. The second EPD panel 100a stores, in the third memory (not illustrated), the copied image data received from the electronic device 1000a, and transfers the copied image data to the second image sheet 120a at the same time.

The present invention provides a method through which image data can be easily shared between electronic papers, without any complex connection method.

It may be appreciated that the embodiments of the present invention can be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It is noted that a memory, which may be included in an electrophoretic display (EPD) panel or an electronic device, is an example of a storage medium suitable for storing a program or programs including a command for realizing embodiments of the present invention, the storage medium being read by a machine Therefore, embodiments of the present invention provide a program including codes for implementing a system or method claimed in any claim of the accompanying claims and a machine-readable device for storing such a program. Moreover, such a program as described above can be electronically transferred through an arbitrary medium such as a communication signal transferred through cable or wireless connection, and the present invention properly includes the things equivalent to that.

Further, the EPD panel or the electronic device may receive the program from a program providing device connected thereto in a wired or wireless manner, and may store the program. The program providing device may include a program including instructions by which the EPD panel or the electronic device performs an image transfer method set in advance, a memory that stores information required for the image transfer method, a communication unit that performs wired or wireless communication with the EPD panel or the electronic device, and a controller that transmits the corresponding program to the EPD panel or the electronic device in response to a request of the EPD panel or the electronic device, or automatically.

While the present invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method of transferring images between electronic papers, the method comprising:
copying image data stored in a first electronic paper while the first electronic paper is connected to an electronic device; and
transferring the copied image data to at least one second electronic paper such that the copied image data is displayed on the at least one second electronic paper while the at least one second electronic paper is connected to the electronic device.

2. The method of claim 1, wherein the at least one second electronic paper comprises a first connector exposed on a front surface and a rear surface thereof, and the electronic device comprises a second connector exposed on a front surface thereof.

3. The method of claim 2, wherein the first connector of the at least one second electronic paper and the second connector of the electronic device are connected with each other in a direct contact manner.

4. The method of claim 2, wherein the at least one second electronic paper comprises a plurality of second electronic papers having first connectors, respectively, and the first connectors of the plurality of second electronic papers and the second connector of the electronic device are sequentially stacked to be connected with each other.

5. The method of claim 2, wherein the first electronic paper comprises a third connector exposed on a front surface and a rear surface thereof, and the third connector of the first electronic paper and the second connector of the electronic device are connected with each other in a direct contact manner.

6. The method of claim 1, further comprising:
receiving a user's image transfer command.

7. The method of claim 1, wherein receiving the user's image transfer command comprises:
receiving a command to copy the image data stored in the first electronic paper through a first button installed in the electronic device.

8. The method of claim 7, wherein receiving the user's image transfer command further comprises:
receiving a command to transfer the copied image data through a second button installed in the electronic device.

9. An electronic paper comprising:
a memory that stores first image data;
an image sheet that displays the first image data;
a connector that is exposed on a front surface and a rear surface of the electronic paper; and
a controller that outputs the first image data stored in the memory to an external device through the connector.

10. The electronic paper of claim 9, wherein the controller displays second image data, input from the external device through the connector, on the image sheet.

11. The electronic paper of claim 9, wherein the image sheet comprises:
bottom and top substrates of a plastic material;
an ink layer that is interposed between the bottom and top substrates, and displays an image pattern through a movement of particles according to an applied electric field; and
a backplane that is interposed between the bottom and top substrates, generates the electric field, and has a conductor of an organic material and an insulating layer.

12. The electronic paper of claim 11, wherein the image sheet further comprises:
a common electrode that is interposed between the bottom and top substrates.

13. A non-transitory computer-readable storage medium storing one or more programs, which when executed implement a method of transferring images between electronic papers, the method comprising the steps of:
copying image data stored in a first electronic paper while the first electronic paper is connected to an electronic device; and
transferring the copied image data to at least one second electronic paper such that the copied image data is displayed on the at least one second electronic paper while the at least one second electronic paper is connected to the electronic device.

14. An article of manufacture for transferring images between electronic papers, comprising a non-transitory computer-readable storage medium storing one or more programs, which when executed implement the steps of:
copying image data stored in a first electronic paper while the first electronic paper is connected to an electronic device; and
transferring the copied image data to at least one second electronic paper such that the copied image data is displayed on the at least one second electronic paper while the at least one second electronic paper is connected to the electronic device.
